(19) United States
(12) Patent Application Publication
(10) Pub. No.: US 2007/0196808 A1
(43) Pub. Date: Aug. 23, 2007

(54) SYSTEMS, METHODS, AND SOFTWARE FOR ONLINE COURSES

(75) Inventor: Patrick Call, Vashon, WA (US)

Correspondence Address: SCHWEGMAN, LUNDBERG, WOESSNER & KLUTH, P.A., P.O. BOX 2938, MINNEAPOLIS, MN, 55402, US

(73) Assignee: THOMSON LEARNING INC.

(21) Appl. No.: 11/687,527

(22) Filed: Mar. 16, 2007

Related U.S. Application Data
(63) Continuation of application No. 11/492,680, filed on Jul. 24, 2006.
(60) Provisional application No. 60/701,571, filed on Jul. 22, 2005.

(51) Int. Cl. G09B 3/00

(52) U.S. Cl. 434/350

(57) ABSTRACT

Various online educational systems, components, methods, and software are presented.

### RELATED APPLICATION

This application claims priority to U.S. Provisional Application 60/701,571, which was filed on Jul. 22, 2005 and which is incorporated herein by reference.

### COPYRIGHT NOTICE AND PERMISSION

One or more portions of this patent document contain material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright© 2004-2005, Thomson Corporation.

### TECHNICAL FIELD

Various embodiments of the present invention concern online educational systems, such as those that employ some form of client-server architecture.

### BACKGROUND

The 1990s witnessed a rapid proliferation of computer technology into homes and businesses. During this time, computers, fueled by growth of the Internet, advanced from facilitating tasks, such as word processing and bookkeeping, to become everyday communications tools, fast approaching the commonness of telephones and televisions. As a result, virtually every sector of public, private, and commercial life has been affected in some way by the power and reach of today's computer technology.

The education and training industry, for example, has rapidly deployed computer technology, particularly network technology, to facilitate distance learning. Although this technology has expanded the availability and accessibility of educational content to millions of students, the present inventors have recognized at least four problems. First, much of the best available educational content is owned by private commercial companies and delivered through their respective proprietary platforms. These platforms lack effective mechanisms for multiple parties to share their content. Second, education in an online environment exposes teachers and students to the risks of system failures, which generally entail significant loss of data and/or significant user inconvenience. Third, conventional systems that provide tutorial content lack effective mechanisms for enabling users, such as teachers, to provide automated access to additional tutorial resources. And fourth, conventional systems lack effective mechanisms for repurposing or customizing educational content to different types of users.

Accordingly, the present inventor has recognized various needs to improve online educational systems.

### SUMMARY

To address one or more problems or shortcomings of conventional online educational systems, the present inventors devised, among other things, one or more novel systems, methods, and software. One exemplary system includes problem type web services: These web services provide for integration of proprietary online educational content into third party applications as well as integration of third party content into a proprietary educational system. The exemplary system is designed such that the external content can be embedded tightly within existing internal content system.

The exemplary system also provides a session persistence framework that is designed to function as a failover system for system errors that make a server unresponsive. Users of the exemplary online educational system that are connected to a failing system are transparently moved to another system without losing their client session state, such as assessment progress. Additionally, the exemplary system includes active tutorial content. For example, when users are interacting with tutorial content, this system provides a way of associating related resources with the original item. These resources can be displayed when the online system detects that the user needs additional assistance. This allows for the creation of cross product referencing and expands the student's experience.

Another feature of the exemplary system is custom feedback switching based on book metadata, which, for example, allows the same online educational content, such as a document, to be presented in a free version as well as a paid version, each having a different feedback mode. This ultimately represents a way of reusing content in different markets and a potential marketing opportunity to get users to upgrade to paid versions of content.

### BRIEF DESCRIPTION OF DRAWINGS

FIG. 1 is a diagram of an exemplary information-retrieval system 100 corresponding to one or more embodiments of the invention.

### DETAILED DESCRIPTION OF EXEMPLARY EMBODIMENT(S)

This entire document, which reference and incorporate one of more figures and the appended claims, describes and illustrates one or more exemplary embodiments of one or more inventions. Various embodiments not expressly shown may be realized by combination of various components of other embodiments. These embodiments, offered not to limit but only to exemplify and teach the concepts of these one or more inventions, are shown and described in sufficient detail to enable those skilled in the art to make and use the one or more inventions. Thus, where appropriate to avoid obscuring the one or more inventions, the description may omit certain information known to those of skill in the relevant art.

Additionally, the exemplary system referred to herein is understood to be implemented in a thick or thin client-server environment over a local or wide area wireline or wireless network. Exemplary client devices (more generally clients) are equipped with browsers and may take any number of forms, including desktop personal computers, notebook computers, personal-digital assistants, mobile telephones, etc. In some embodiments, one or more of these devices are equipped with internet browsers and/or operating systems that provide graphical user interfaces implemented as user interface features or elements. Users use their client devices to access and view data through interfaces defined at least partly by software within a server or downloadable application.

Various features or embodiments described herein may be combined individually or collectively with other features and/or embodiments described herein to realize other embodiments. Additional embodiments may be realized through combination of these features or embodiments with one or more of those in U.S. provisional patent application 60/592,238 which was filed on Jul. 29, 2004 and which is incorporated herein by reference.

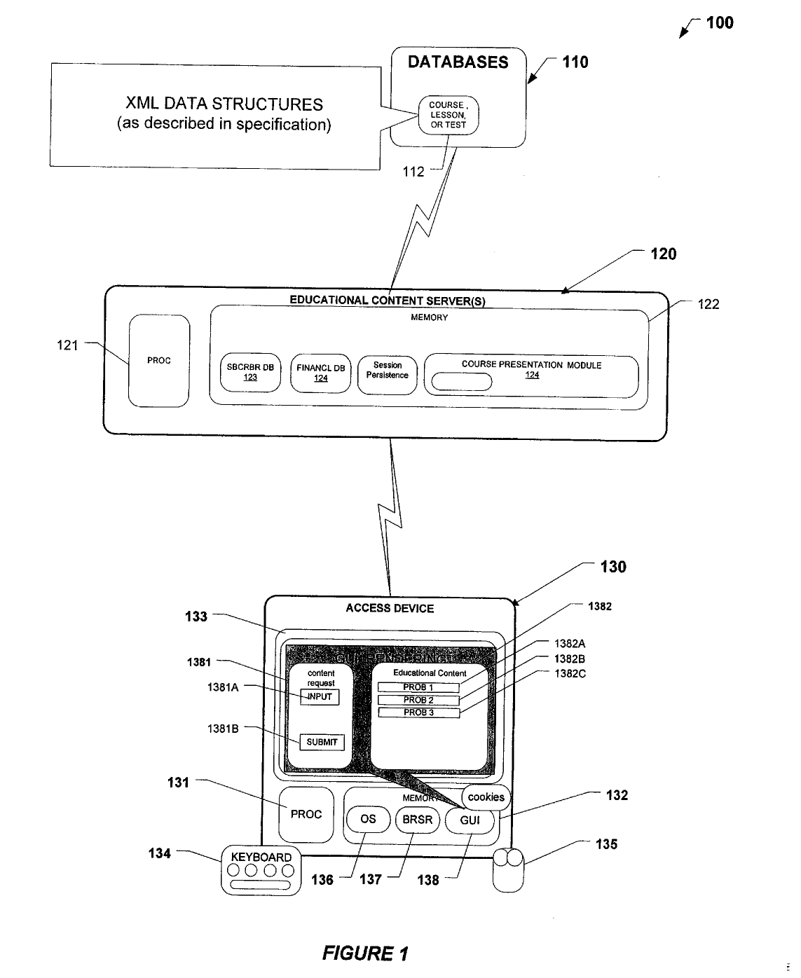

FIG. 1 shows an exemplary online educational or training system 100. System 100 includes one or more educational databases 110, one or more servers 120, and one or more access devices 130.

Educational databases (or data stores) 110 includes a set of primary databases 112, a set of secondary databases 114, and a set of other databases 116. Primary databases 112, which in the exemplary embodiment generally provide content from a textbook publisher such as Thomson Learning, includes a text book database 1121, an examples database 1122, and an assessment documents database 1123. Text book database 1121 provides one or more professional or academic texts or training manuals for various levels of students, spanning the range from adult professional learners to juvenile learners.

Secondary databases 114 includes teacher-produced educational content that is intended to supplement or complement materials in primary databases 112. In the exemplary embodiment, this includes supplemental text database 1141, supplemental examples database 1142, and supplemental assessment content 1143.

Other databases 116 generally includes any relevant content not explicitly available in databases 112 and 114. For example, in some embodiments, other content includes content available through search engines such as the Infotrac search engine, the Yahoo search engine, etc. Some embodiments may also access pay-for-access search engines.

In the exemplary embodiment, databases 110 and 120, which take the exemplary form of one or more electronic, magnetic, or optical data-storage devices, include or are otherwise associated with respective indices (not shown). Each of the indices includes terms and phrases in association with corresponding document addresses, identifiers, and other conventional information. Other embodiments may include conventional keyword indices such as used in Google, Yahoo, or MSN.

Databases 110 are coupled or couplable via a wireless or wireline communications network, such as a local-, wide-, private-, or virtual-private network, to server 120.

Server 120, which is generally representative of one or more servers for serving data in the form of webpages or other markup language forms with associated applets, ActiveX controls, remote-invocation objects, or other related software and data structures to service clients of various “thicknesses.” More particularly, server 120 includes a processor module 121, a memory module 122, a subscriber database 123, a primary search module 124, secondary search module 125, a web search and crawler module 126, and a user-interface module 127.

Processor module 121 includes one or more local or distributed processors, controllers, or virtual machines. In the exemplary embodiment, processor module 121 assumes any convenient or desirable form.

Memory module 122, which takes the exemplary form of one or more electronic, magnetic, or optical data-storage devices, stores subscriber database 123, primary search module 124, secondary search module 125, educational software module 126.

Subscriber database 123 includes subscriber-related data for controlling, administering, and managing pay-as-you-go or subscription-based access of databases 110. In the exemplary embodiment, subscriber database 123 includes one or more user data structures, of which data structure 1231 is representative. Data structure 1231 includes a customer or user identifier portion 1231A, which is logically associated with one or more data fields, such as data fields 1231B, 1231C, 1231D, 1231E, 1231F, and 1231G.

Data field 1231B includes a listing of one or more course or content set identifiers which the corresponding user is authorized to access. Data field 1231C includes a listing of one or more progress or completion indicators which indicate what portions of a course or content set the corresponding user has completed generally or has obtained a satisfactory result in. Data field 1231D includes one or more bookmarks and/or other state defining variables to enable the system to start or restore a user session back to the state immediately prior to session termination. Data field 1231 includes one or more assessment results or assignment grades for the corresponding user. In the case of teacher, the data structures generally includes class roll, content, and grade information that the teacher is authorized to access.

Primary search module 124 includes one or more search engines and related user-interface components, for receiving and processing user queries against one or more of primary data-bases 112 or other databases 116. In the exemplary embodiment, one or more search engines associated with search module 124 provide Boolean, tf-idf, natural-language search capabilities.

Secondary search module 125 includes one or more search engines for receiving and processing queries against one or more of secondary and/or other primary databases 114 and 116. In the exemplary embodiment, one or more search engines associated with search module 124 provide Boolean, tf-idf, natural-language search capabilities.

Educational software module 126 includes machine readable and/or executable instruction sets for wholly or partly defining web-based user interfaces, such as user interface 138 and related functionality within one or more accesses devices, such as access device 130.

Access device 130, which is coupled or couplable via a wireless or wireline communications network to server 120, is generally representative of one or more access devices. In the exemplary embodiment, access device 130 takes the form of a personal computer, workstation, personal digital assistant, mobile telephone, or any other device capable of providing an effective user interface with a server or database. Specifically, access device 130 includes a processor module 131 one or more processors (or processing circuits) 131, a memory 132, a display 133, a keyboard 134, and a graphical pointer or selector 135.

Processor module 131 includes one or more processors, processing circuits, or controllers. In the exemplary embodiment, processor module 131 takes any convenient or desirable form. Coupled to processor module 131 is memory 132.

Memory 132 stores code (machine-readable or executable instructions) for an operating system 136, a browser 137, and a graphical user interface (GUI) 138. In the exemplary embodiment, operating system 136 takes the form of a version memory 132. of the Microsoft Windows operating system, and browser 137 takes the form of a version of Microsoft Internet Explorer. Operating system 136 and browser 137 not only receive inputs from keyboard 134 and selector 135, but also support rendering of GUI 138 on display 133. Upon rendering, GUI 138 presents data in association with one or more interactive control features (or user-interface elements). The exemplary embodiment defines one or more portions of interface 138 using applets or other programmatic objects or structures from server 120, particularly as defined by educational software module 126. More specifically, graphical user interface 138 defines or provides one or more display regions, such as regions 1381, 1382, 1383, 1384, and 1385, each of which is defined in memory and upon rendering includes one or more interactive control features (elements or widgets).

In the exemplary embodiment, one of more of these control features takes the form of a hyperlink or other browser-compatible command input, and provides access to and control of query region 1381 and search-results region 1382. User selection of the control features in region 1382 results in retrieval and display of at least a portion of the corresponding document within a region of interface 138 (not shown in this figure.) Although FIG. 1 shows query region 1381 and results regions 1381-1385 as being simultaneously displayed, some embodiments present them at separate times based on user selection or navigation. Details of the exemplary interfaces are further described below and/or in other portions of this document.

### Exemplary Operation

The description describes the operation or process flow of one or more exemplary methods of operating a system, such as system 100, in terms of functions, operations, or blocks in a serial sequence within an exemplary embodiment. However, some embodiments execute two or more blocks in parallel using multiple processors or processor-like devices or a single processor organized as two or more virtual machines or sub processors. Some embodiments also alter the process sequence or provide different functional partitions to achieve analogous results. For example, some embodiments may alter the client-server allocation of functions, such that functions shown and described on the server side are implemented in whole or in part on the client side, and vice versa. Moreover, still other embodiments implement the blocks as two or more inter-connected hardware modules with related control and data signals communicated between and through the modules. Thus, the exemplary process flows in this description) applies to software, hardware, firmware, and other desirable implementations.

Exemplary Session Persistence

This section describes an exemplary implementation of session persistence, and details the options used to enable and configure it on a server, such as server 120. (Similarly, other portions of this document describe structures, functions, and methods that may be deployed in the context of system 100.

The purpose of this session persistence implementation is to provide a safety net for user data when servers become unavailable unexpectedly. Previously, all session information was stored in memory only. While all session information is important, there were some basic pieces such as the user ID that were required for a user to stay logged into the system. If these pieces of data were lost, the user was immediately sent to the front porch (login area) and required to log in again. In addition, our load balancer worked as a redirector and the user would be connected to a specific server, rather than the load balancer. Therefore, the symptoms of losing session information when a server process crashed were timeout messages from the browser, followed by being sent to the front porch when the specific server became available again, or when the user reconnected to the load balancer.

When users (especially students) were in the middle of a test taking activity, the state of the test taking activity was lost. This means that the user would have to restart their test from the beginning, and that they were penalized by losing one “take” of a test. The design goals for this implementation were to reduce or minimize the amount of data loss in specific areas, such as log in status and state of test taking activities. While the current system does not provide 100% reliability or preserve all user session data at this time, it does provide a mechanism that will reduce the amount of data lost if a server crashes. Coupled with the new load balancer system, users will have a smaller interruption to their experience.

One of the main goals of this exemplary system is that users remain logged in after a server becomes unavailable and they are migrated to a different server. The process should be seamless to the user and the user does not need to log in again to have their data restored. To this end, session data is periodically stored in a database, such as database 110 or another database within or separate from server 120, and the keys to this data are stored in client cookies on an access device, such as access device 130. If a server becomes unavailable, the load balancer will redirect them to another available server. The new server will detect that the user has lost their previous connection by the lack of session information stored in memory. It will use the client cookies to restore data from the database. The user will be notified through a message that their session was restored as an explanation for any interruption the user might notice. The degree of this interruption depends on the activity that user is performing and which session classes have been coded to enable session persistence. It is hoped that the small number of classes operational at the time of this writing will increase with time.

Exemplary Operation

SessionData Database Table

Another facet of the exemplary implementation is the inclusion of a SessionData table to the database. The details of this can be viewed in the main.sql file. Indexes are created on the table to speed frequent queries.

Server Options

There are several options that can be specified in the options.xml file to enable and configure session persistence. These options also have defaults, which are specified in the web.xml file. These options are described below

Unique Server Name

While there was already an option for specifying a DNS server name with the localServerName option, with the load balancer enabled this should always point at the load balancer. Therefore the uniqueServerName option was introduced to hold a server name that can be associated with a user's location.

In the exemplary embodiment, this must be configured for each server and must be unique across all the servers, or unexpected behavior could occur. Therefore the local-options.xml file may be used to hold this variable. This name does not need to match a DNS name. It is a symbolic name used only for session persistence.

Session Persistence Type

The sessionPersistenceType option configures whether session persistence is enabled and which type of persistence to use. The options are currently
none—Session persistence is disabled (default).
database—Database persistence will be used. This should be enabled for the live site.
hashtable—Hashtable persistence will be used. This mode is for testing purposes as it does not persist data out of memory.
   This option may be changed while the server is running and the persistence manager will be altered accordingly. Thus the persistence framework may be dynamically enabled and disabled.

Session Persistence Interval

Use the sessionPersistenceInterval option to configure how often data will be persisted. This is a numeric value in milliseconds. The default is to persist every 30 seconds. Most session data at this time is passively persisted and this will occur according to this interval. Some session classes may request immediate persistence after an important operation. This is true for the test taking activities, which persist after each item is answered.

Database Persistence Database URL

Use the databasePersistenceDb option to specify a JDBC URL. In the exemplary embodiment, this apples only when the database session persistence type has been specified. This option is used to specify a separate database URL to use that should contain the SessionData table. If this option is not specified but the database persistence is used, the main the exemplary iLrn system database server will be used (as specified by the db option).

This option is specified as a JDBC URL. Changes to this option while the server is running do not affect the current persistence manager's settings. The system would need to be disabled and re enabled to reflect a change in this setting.

Database Persistence Cleanup Interval

This applies only when the database session persistence type has been specified. Although the persistence manager attempts to keep session data cleaned up when users time out or log out. There are a few cases where session data cannot be cleaned up immediately by the system, such as after a system crash. The persistence manager therefore cleans up old records periodically. This option specifies the interval between these cleanup operations.

This option is called databasePersistenceCleanupInterval. This is specified in milliseconds and defaults to 30 minutes. This probably does not need to be changed.

Database Persistence Max Data Age

This applies only when the database session persistence type has been specified. The databasePersistenceMaxDataAge specifies the maximum age of session data records for the cleanup task described above. Records older than this value, specified in milliseconds, will be deleted. The default is 3 hours, which is longer than the normal session timeout in the exemplary iLrn system.

Logging

Detailed information on the operation of Session, the SessionManager, and the SessionPersistenceManager are logged under the common category DBG.SESSION. When troubleshooting this system logging should be enabled. In a production setting, this will create a large amount of output, and should only be enabled if necessary.

The session debugging messages may be easier to read if placed in a separate file, such as with the following logSpec value:

INFO.1,ERR,data/logs/logFile.txt;DBG.SESSION,data/logs/logSes.txt

Performance Statistics

Statistics on the performance and operation of this system are calculated and reported in the dashboard file. The following stats are reported:

Size of Persisted Data

The sessionPersistenceSize statistics track the size of persisted objects, and are reported in bytes.

This is calculated for each session object. One user will have several session objects.
minimum—The minimum size of a persisted session object.
maximum—The maximum size of a persisted session object.
mean—The arithmetic mean (average) size of all persisted session objects.
std-deviation—The standard deviation from the mean for all persisted session objects.
total—The total size of all persisted data.
   Time to Persist Data

The sessionPersistenceTime statistics track the amount of time it takes from the time data is requested to be persisted to the time it is actually stored. This is reported in milliseconds. Since data persistence occurs asynchronously, the client is not waiting during this time period. Large values here, especially larger than the configured sessionPersistenceInterval could indicate a performance problem.
minimum—The minimum amount of time a request waited.
maximum—The maximum amount of time a request waited.
mean—The arithmetic mean (average) of request processing times.
std-deviation—The standard deviation from the mean for all processed requests.
num-samples—The total number of persistence requests serviced.

Processing Errors

The number of error encountered when processing persistence requests are given in the sessionPersistenceErrors-num-samples statistic. These errors are logged along with other session debug information in the DBG.SESSION category as well as to the application error log (the ERR category).

Client Cookies

Information needed to restore session state is stored in client cookies. The two cookies needed are:
sessionId—Like the JSESSIONID cookie, this stores the Tomcat session ID. However since Tomcat may overwrite the JSESSIONID cookie at any time, another cookie that the exemplary iLrn system has complete control over is used.
sessionServer—Stores the unique server name of the real server the user is connected to behind the load balancer. This is required since session ID's a generated by each server and it is possible (though unlikely) that two servers could generate the same session ids for difference sessions.
   Testing

The basic testing scenario involves a user connected to a server with session persistence. At some point the server should be shut down, then restarted. The user should notice a minimum of disruption to their experience. A list of objects currently being persisted is given below. Other session activities will need to be resumed from the beginning when the session is restored, until the support for these activities has been coded.

For further testing, a load balanced pool must be used. Two QA servers should be set up in the pool with persistence enabled. Make sure the uniqueServerName option has been set properly. A user should log in and user the system, then at some point one server should be shut down. The user should be redirected to the new server by the load balancer and should see a minimum of disruption. In both cases, a global listener message window should appear when the session is restored, as an explanation for any disruption that may occur. Users are told to contact technical support if they experience any other problems.

Data Currently Persisted

Login status—User ID, institution, last access time, locale, and the list of other session objects for the user.
Tabs—The users' list of tabs, current tab order, etc.
Test taking state—When taking a test, the disruption should be minimal. The user should stay in the same “take”, have the same answers, same item number, etc.
Tutorial state—When using a tutorial, the section the user is in, the item they are working on, etc. should be persisted.
   Design

Javadocs are provided in the code, but a high level design for the classes involved is given here.

Session Persistence Manager

The session persistence manager was introduced to track the persistence of all sessions. This is configured by the Application and set within the SessionManager. Each Session object also stores a reference to the persistence manager. When the persistence is disabled, this will be null.

The AbstractSessionPersistenceManager handles base functionality while the concrete DatabaseSessionPersistenceManager and HashtableSessionPersistenceManager fill in the details.

Database Persistence

The database persistence manager holds its own Connection, and creates some PreparedStatement objects, which are used repeatedly for performance. Therefore, it is normal to see these connections open in the Manage Server Status page.

Persisted Data

In order to participate in the persistence framework, objects stored in the exemplary iLrn system Session must implement the PersistableSessionData interface. This is mainly a marker interface and also requires that the object be able to store a data key for persistence. This interface extends serializable, so classes must serialize properly as well. Once a class implements this interface it will be persisted automatically.

A note on threading issues: The serialization and persistence happens asynchronously on a dedicated thread. Therefore classes that are persistable must also be thread safe with respect to serialization to persist and restore in a consistent state. This is likely to be a source of errors as we migrate existing session data into this framework, because most of these objects are not thread safe and this could expose new issues with them.

In addition to the PersistableSessionData interface, the ObservableSessionData interface allows session data to interact with the persistence manager (or other SessionDataObserver objects) in a more active way, informing them when the object is changed and should be persisted.

Memory Storage

The MemorySessionStorage class already handles many of the details regarding Session creation and storage. Now when a request is made to locate a Session for a HttpRequest, if the initial checks fail, an attempt is made to restore the session from the persistence manager using the client cookies for the session ID and server name.

Session Changes

The session was modified to hold a reference to the persistence manager, and the session manager requests that the session persist itself periodically. The session then creates a new BaseSessionState object to persist its internal state under the special data key_BASE_. This object contains a list of the keys for all other persisted data and other Session members such as user ID. It also holds some simple objects like the classes for Java primitives (Integer, Long, etc.).

The base session state is the first to be restored, and then each persisted object is restored. When the session has been restored, the success status of this operation is stored, for later use by the ShellModule.

ShellModule

The ShellModule class looks for sessions that have been restored during initialization. If it finds a session that has been restored, it creates a notification for the user's new session, and a message should be displayed to the user the next time a request for global messages is made.

Design Specification for the Exemplary iLrn System 4.0

Database Based or File Based Session Persistence

Introduction

This document presents a proposal for the design of a file based session persistence system for the exemplary iLrn system. The functionality described is scheduled for the 4.0 version of the exemplary iLrn system, to be released in the summer of 2004.

Problems with Current System

The current session storage system for the exemplary iLrn system is memory based and server specific. That is, once a session is created for a user on a server, the user session is attached to the server for its duration. While this approach provides some advantages in the form of predictability and performance, its disadvantages are far greater.

Sessions are not currently serialized; they exist in memory as Java objects. We use the Tomcat session system to associate client requests with sessions. Inside the HttpSession we store a single object, a Session, which we then use to store all user session state.

The most severe limitation of this system is that since the sessions exist in memory, any failure or shutdown of the Java process results in session loss for all users connected to the server. Users must then log in again and reinitiate any tasks. This makes keeping servers available critical when any users are connected, and it makes the process of rebooting servers for maintenance or updates very time consuming, as we must wait for all users to log out of the application.

Our load balancer is thus constrained to function as a one-time redirector. In other words, users are assigned to specific servers when they first log in, and their sessions remain on that particular server. Problems arise when users bookmark pages, which point at specific servers and thus bypass the load balancer Additional problems exist for users with low-bandwidth connections. The browser caching mechanism is based on server URLs and so the same copy of an applet jar may need to be downloaded multiple times if the user connects (in multiple sessions) to multiple servers. These issues make it clear that a different session management system is needed.

Proprietary Solution Proposed

We have been planning on migrating our application to enterprise application standards such as J2EE. Some application containers offer many of the features needed to solve the problems noted above. It would be desirable to utilize these features where possible and avoid implementing a custom solution. Taking advantage of the container requires adherence to specific patterns for classes that wish to utilize clustering functionality. Given the timeframe we have in which to implement a solution to the problems above, making the architectural changes across the exemplary iLrn system platform to fit into the J2EE framework is not possible. We are therefore proposing a proprietary solution to address our present needs.

As we take advantage of container services in the future, we plan to evaluate this system to find opportunities to offload persistence and clustering responsibilities.

Exemplary Requirements

Persistent Sessions

The exemplary system write sessions to disk or other non-volatile storage so that application shutdown or failure does not result in data loss.

Proxy Based Load Balancer

The load balancer should be a proxy based system so that clients always point at one server DNS name, such as the exemplary iLrn system.brookscole.com. The load balancer should be responsible for forwarding requests transparently to the client.

SSL Support

The load balancer must work within an SSL environment, since we are planning on utilizing SSL heavily for the secure transmission of grades.

Design

Our proposal for the design and architecture of the new system to accommodate the requirements above follows.

Load Balancing

Several options exist for load balancing web applications. The options and their consequences are discussed below.

Logical View of Networked Services

Below is a diagram that outlines the network components. Not all components must be on separate machines; for example the NFS server and the ServerHub could coexist on the same machine.

[image]

Linux Virtual Server Project

LVS is a load balancing solution that operates at the transport layer (layer 4 in the OSI model). It essentially functions as a router with special rules for routing requests to specific servers based on load. It is available in current Linux 2.4 kernels and open-source software supports its use and configuration.

The fact that this is a low level solution has some advantages and disadvantages, compared with load balancing solutions that work at the application level. The advantages include its free availability, simplicity of function, and high performance. The main disadvantage is the issue with masqueraded clients discussed below.

LVS provides a connection persistence mechanism that allows requests from a client to be affiliated with a single real server, as long as the client is not idle for longer than a configurable duration. This approach would allow us to keep clients on a server for reasonable periods of time, reducing the frequency of server changes and the session synchronization overhead involved. The problem with this system is that the client to server mapping is maintained by IP address, and some networks may be set up with NAT or proxies that hide large numbers of clients behind a single IP. In this case, requests from multiple clients would all be forwarded to a single real server, creating performance problems.

We can easily envision such scenarios, for example with many users in a university computer lab taking a test. If the lab is configured to use a single NAT gateway, we would be unable to load balance the requests from the lab. We already have an example of this situation with Monroe Community College. This issue alone rules out our use of LVS as a load balancing option.

Layer 4-7 Load Balancing Solutions

As noted above, the main issue with using a low-level load balancer is that client connections cannot be tracked at a fine enough granularity. In order to track a logical client session, the load balancer must be able to examine the contents of request packets and parse session tracking information. These level 4-7 load balancers take the form of software packages and dedicated hardware units.

Software Packages

These packages allow the tracking of client sessions at the logical client level, through the inspection of http headers, cookies, and SSL ids. It is in SSL support that these packages fall short of their mark.

The packages we evaluated did not (for performance reasons) support the inspection of encrypted requests, so requests using SSL were tracked using the SSL id. One disadvantage here is that the http requests cannot be modified to include the original client request data, essentially crippling logging and tracking services. It would appear to the exemplary iLrn system servers that all requests originate from the load balancer. The only workaround is to use proprietary extensions to SSL that are supported only when using the proprietary web server supplied by the load balancer vendor, an option we deem unacceptable at this time.

In addition, some browsers renegotiate SSL connections periodically, so we would have little control of when clients are moved from system to system.

Hardware Units

Our research indicates that there are hardware solutions that accommodate all our needs. They can decrypt and inspect SSL encrypted packets. The only apparent disadvantage here is the high cost. These hardware systems can handle large amounts of traffic and include dedicated SSL hardware systems. The SSL acceleration is a desirable feature, especially in light of our current plans to host the entire site and all its pages using SSL. This approach is being considered due to school policies regarding privacy and security for the recording of students' answers and display of grades. Utilizing a hardware based load balancing solution allows all SSL handling to occur one system, allowing more resources to handle request processing on our web servers. It also simplifies SSL configuration and allows one SSL certificate to be used for all servers.

The units under consideration are the BIGip 1000 from F5 networks, the Radware Application Switch 1, and the Cisco CFS-501. For SSL, Radware sells a module that integrates with the Application switch. All packages would accommodate our needs with room to scale.

After analyzing our traffic using NetTracker, we came up with the following statistics: for all our traffic for both data sites, we have a maximum of approximately 8 million hits per day, and 120 Gigabits of traffic, with an estimated peak of 300 hits/second and 3 Mbps of traffic.

Both the BIGip and Radware units support around 100 Mbps of sustained traffic. The Radware unit supports 350 SSL request/response-pairs/second, which is license limited and can be increased if necessary, up to several thousand if needed. In contrast to the Radware unit, which limits response/request pair rate, the BIGip license limits new SSL handshakes, which are performed when clients initially connect. Requests and responses are not limited. The BIGip has a license limit of 100 new SSL handshakes per second (which can be increased to 800) and the bulk encryption/decryption operates at 100 Mbps. The BIGip unit supports more options for tracking sessions, as it supports an expression based syntax that can examine the first 16K of request data in determining how to map a client to a server. This capacity is more than sufficient to track requests with Tomcat cookies, and BIGip has claimed that their next software release, scheduled for the third quarter of 2004, will support scanning the entire request and provide a richer set of functions.

Intraserver Communication

Although the load balancer handles mapping clients to servers, our application has several responsibilities to perform in the clustered configuration. If we wish to support the ability to take systems out of the load balancer dynamically, or redirect clients to other servers dynamically, synchronization must occur to ensure that session data is consistent from one server to the next. In addition we have an application level database cache that needs to be synchronized across servers.

The ServerHub process will be introduced to service these needs. This will be a separate Java application that will serve as central hub between a set of clustered servers. Servers will be autonomous in many ways, but where they need to communicate with other servers, they will do so through the ServerHub.

Servers will register themselves with the ServerHub at application startup time, and unregister themselves when shut down.

RMI will be used as the communication protocol for this service. Since RMI is a synchronous protocol, some work will need to be done to provide support for asynchronous and timed messages. Evaluation of available frameworks to accommodate this part of the project is ongoing.

Persistence System

Serialization

We plan to use the standard Java object serialization system to write sessions to disk. Our Session class will implement the Serializable interface to allow this. We currently have a class structure that allows us to plug different storage mechanisms into our SessionManager. 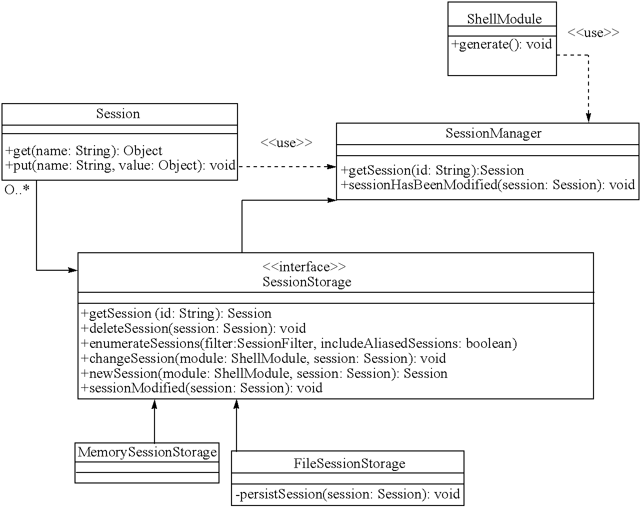
Our current production server uses the MemorySessionStorage implementation. We will switch this to use the FileSessionStorage implementation.

Periodically, the session will be serialized, and an MD5 sum calculated on the serialized bytes. The MD5 sum will be compared with the last sum, and if there are differences, the bytes will be written to the shared network filesystem.

[image]

The interval between serialization attempts will be configurable. If a server failure occurs, any outstanding changes to the session data will be lost. We cannot serialize with each logical change to session data, however, because the performance cost would be prohibitive. We will therefore choose an interval that is long enough to accommodate our performance needs based on session size and number of sessions, while minimizing the potential for data loss. Some optimizations could occur, such as allowing the period to be dynamic based on load. As the number of sessions increases, we would then throttle back on the rate at which we persist sessions. The information on persistence rate could be collected by the ServerHub process.

We will also support immediate persistence so that critical changes can be written immediately, as well as to accommodate transition from one server to another (discussed below).

[image]

Synchronization using ServerHub

Several events need to take place when the session is serialized. In order to synchronize access across servers, the ServerHub process will be used.

In order to prevent race cases and data being overwritten, we will enforce a model where only one server may manage a client session at a time.

At any point in time the client will be associated with one server, and that server will have access to the session, plus the ability to write it to the disk. Data will be written periodically, and at any point in time, the client could be swapped to another server. At this point the new server cannot take over the session because the original server may have unpersisted changes.

The server hub will coordinate such handoffs so that session data remains consistent. A message will be sent to the server hub, which will in turn request the server currently managing the user's session to persist any remaining changes and hand over the management responsibility to the new server.

[image]

Network File Access

A shared network filesystem will be used to store persisted session information. This will be hosted on a separate server machine with a large amount of memory. The OS level caching will be used to provide high speed reads for deserializing sessions. This server will be connected to the server pool via a gigabit Ethernet connection so the network speed should not be a major bottleneck Currently the network filesystem being considered is NFS. NFS has a reputation for some security concerns but we will be able to address these in our location through the use of port blocking. Another available service is AFS, which has a more robust security model; it also allows options for replication and caching. We will evaluate AFS further to determine if it offers significant advantages for our application.

Cache Synchronization

Currently an application level cache is maintained for data records. Values are cached for a period of time that varies according to the record type. This approach means that as updates occur to the database, servers may have stale data for a period of time. With our current schema and level of data sharing for concurrent users, we have not experienced problems with this configuration. When clients can move across servers at any point in time, due to load balancing decisions or failover, this issue will become more problematic, as a client could take an action that affects database information, then move to a different server with stale information.

We cannot easily remove the use of this cache. A large amount of code assumes looking up, and accessing records is in general a cheap operation. These functions are ensured by the use of the cache. We therefore provide a mechanism for synchronizing the caches.

We will use the ServerHub process to provide this functionality. Servers will be required to register themselves with the ServerHub process to participate in cache synchronization. When a record is updated, information identifying the record (type of record, institution, and row id) will be sent to the ServerHub, which will inform all other servers of the update. These servers will be required to flush the cache record if present and query the database to receive the updated information. This approach will reduce the period of time during which data is unsynchronized to a few milliseconds.

Asynchronous calls will be used to send these messages, so that the server performing the update is not required to wait for notification of all other servers to continue processing.

[image]

MathNOW—Advanced Homework Type

(Premium Content)

Student Side

The “Advanced Homework Type” provides students with immediate help when they approach a problem in their homework assignment that they cannot solve themselves. What we want to offer is a link within the test item that is correlated to a tutorial item (we will call this item an “Active Example”) covering the same concept as the test item. The following screenshots put this requirement into a visual presentation:

[image]

Problem Types from Tussy/Gustafson 3e

These are the entire problem types (PTs) included in the Tussy/Gustafson Elementry Algebra 3e testbank. Each PT has a consistent place for the link to the Active Example (Tutorial Exercise). We also need to consider that the test might be posted as a WebQuiz and all items are on one page.

[image]

[image]

[image]

[image]

[image]

Production Consideration

To achieve the proposed correlation between the homework and tutorial items we need to establish a seamless production workflow. On average a testbank has about 2400 items. For the 14 proposed books that's about 36,000 items altogether.

Example of Correlation Grid

A testbank is broken into chapters and sections. Each section has about 40 items. Each of these items needs to get correlated with a tutorial exercise. For each section there are usually 6 tutorial exercise items. The following screenshots indicates how this correlation can be communicated to the content producers to perform the production. For each book there would be a spreadsheet broken into chapters, sections and item. By using the “edit book” function within the exemplary iLrn system it is possible to copy and paste the item together with a direct link to the item into the spreadsheet. This would allow the person that is doing the correlation for a quick check on the item to quickly identify the tutorial exercise that can be correlated with the item:

[image]

Production Workflow

At this point I see three parties involved in creating the correlations guides:
The content manager populates the spreadsheet
The SME is adding the correct tutorial to the testbank item
Lunar Logic is adding the active example items to the testbank items
   The workflow therefore looks something like this:

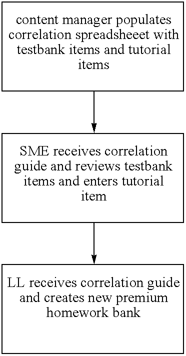

Automatization Script

Automatization of the last step can be easily achieved with modification of the XML of test bank to correlate with a tutorial item. This might be easily achieved by creating a little script that takes the spreadsheet and combines the testbank items with the correlated tutorial items.

Instructor Side

Assigning premium content

Instructors—no matter what adoption they decided on (premium or basic) will always receive access to the entire content package that comes with a book. However, if the instructor assigns premium content there should be a massage telling the instructor that they are about to assign premium content.

The following screenshots show how this can look like:

[image]

Grading

We need a way to grade the active example—or at least see that a student clicked on an active example.

Rejoinder & Feedback1˜Introduction

For the sake of consistency some terms that are commonly inter-changed need to be defined. For the purpose of this document the term “problem type” includes or may be used to refer to one of the available quintessential types of problems that The exemplary iLrn system supports, for example Multiple Choice, Essay, Free Response Math Answer, Fill in the Blank, etc. The term “item” includes or may be used to refer generally to any specific authored item that is defined in a product as XML and is interpreted and displayed to the student as HTML. The term “feedback” includes or may be used to describe the default behavior of displaying one of the messages “Right”, “Wrong”, or “Partially Correct” to the student when they have answered an item in an assignment. The term “rejoinder” is used to describe customized messages that display in addition to or instead of feedback when a student answers an item with the intent of helping the student arrive at the correct answer or to provide additional instruction or clarification. Unfortunately the code and interfaces are inconsistent in their usage of the terms rejoinder and feedback and often inter-change them, which contributes to the confusion surrounding this issue.

One of the goals of this new feature is to give instructors finer grain of control over how rejoinders and feedback are shown to the student in assignments and gradebook in a way that will support existing content. It is also desired that controls be available that restrict the display of rejoinders for specially marketed products based on the same content for products that require purchase of access codes.

. . . Currently rejoinders and feedback are inter-related and the same mechanisms control them both. In general feedback is provided by default unless specific rejoinders are defined. For most problem types the author can create a rejoinder for each correct answer, which will be used instead of the standard feedback when the student uses that answer. Instructor's have the option when creating assignments to display feedback, which includes rejoinders, or not. They do not currently have a way of displaying only feedback or only rejoinders. This is a new requested feature, the ability to toggle display of feedback and rejoinders separately at the assignment level. Additionally requested is the ability to restrict access to rejoinder content through product metadata, in effect hiding rejoinders from instructors and students alike and only allowing feedback to be displayed even if the authored items contain rejoinder content.

There are many special cases that need to be considered and dealt with. Some problem types have additional properties for supporting rejoinders and properties that control the behavior of these rejoinders. An example is Fill In the Blank(FITB) which allows the author to define an “Overall Feedback” property which if left blank will be feedback or if overwritten will be a rejoinder. A second property in FITB called “Feedback mode” allows the author to define whether the overall feedback and/or individual blanks feedback will be displayed. Similarly Multiple Choice(MC) also has an “Overall Feedback” property which only displays when there are multiple correct choices and the student answers incorrectly. MC also has a “solution-feedback” property which is used only for display in the gradebook for certain products as a means for providing the student tips on solving the problem the next time they take the assignment.

2˜Functional Specification

2.1 Hiding Rejoinders for Specific Products

There is a need to take content from a product that contains rejoinders and publish it as a separate product that hides rejoinders and only provides feedback. Ideally this would not require any modification of the original content and updates to the original product can simply overwrite the content of the product that hides rejoinders.

2.2 New Feedback and Rejoinders Assignment Options

The following options are included in the exemplary embodiment for instructors when creating assignments:
1. Disable feedback and rejoinders. Students will only see non-grade related feedback, including error messages, answer accepted and the like.
2. Show only feedback. Students will only see the standard feedback messages “Right”, “Wrong”, “Partially Correct”, or “Answer Accepted” in the case of manually graded only problem types.
3. Show rejoinders where possible. Students will see rejoinders when items are authored to use them, otherwise they will see the standard feedback messages. If the current product being used is flagged for hiding rejoinders this option should work the same as option 2.

Rejoinders are authored in a way that would make feedback for those answers redundant (Question=“2+2”, Answer=“5”, Feedback=“Wrong”, Rejoinder=“Incorrect, check your work and try again”).

3˜Implementation

In this section we describe all information relevant to implementation of the functional requirements described in section 2.0 above. Herein, we provide steps toward meeting the functional requirements.

3.1 Hiding Rejoinders for Specific Products

It is possible to create a new metadata property for products that when present hides rejoinders. The proposed solution will be to create a duplicate of an existing product, add this new property to the new copy's metadata, and publish it as a separate product. Updates to content of the original product can be imported and overwrite the content on the copied product, but the metadata will remain intact. (This allows us to make maintenance changes to one book and then just copy it into the other book, and thus make changes only once.) When present this metadata value will need to override the behavior of the assignment options for displaying feedback and rejoinders, effectively limiting the option to a maximum level of showing only feedback. This will be the responsibility of each activity that displays items to check the product metadata and assignment options and use the appropriate value.

3.2 New Feedback and Rejoinders Assignment Options

New option values will need to be added to the assignment creation page to support the new options in section 2.2. The database will need to support new values for the FeedbackType field in the Assignments table. Entity classes will need to be modified to support these new options.

Changes to the way feedback and rejoinders are rendered can be handled with any of the following approaches:
Approach 1 (playing it safe): Keep the existing HIDE_REJOINDERS RenderingProperties. Property, which is a boolean value that will hide both rejoinders and feedback when on (testing mode), but add a new RenderingProperties. Property which when on ensures no message is written into the grade node, which in effect hides only rejoinders but allows standard feedback to be displayed. This approach means no special consideration for skinned problem types. In order to avoid confusion in the code HIDE_REJOINDERS should be renamed to reflect that it is hiding both feedback and rejoinders.
Approach 2 (refactor): Change HIDE_REJOINDERS from a boolean property to a String property that supports as many values as the assignment options. All problem type XSLs and skins will need to be updated to reflect the changes. No need to modify the grade node, since the XSLs will be changed to look at the new rendering property value instead of testing for custom messages.
   3.3 Special Case Considerations

All problem types will have to be reviewed to determine which have special rejoinder and feedback requirements, MC, FITB, and Matching each have special considerations that will need to be looked at and determine how these new assignment options and product metadata should effect them.

4˜Design Considerations

4.2 New Feedback and Rejoinders Assignment Options

It needs to be determined whether this will be presented under one assignment option or a combination of separate options. We propose that one assignment option with many values be used, rather than a matrix of multiple options. Alternatively, just one switch with multiple settings. The key issue is to make it clear to instructors what choice they are making and the consequences of that choice.

Other Features

Menu/Permission System

Summary

The menu system in the exemplary iLrn system (the online educational system) is tied to the permissions/feature system using some customizations/extensions to Struts. It allows requests from the browser and the Actions they call to be automatically correlated with a menu item for global navigation and with system features.

High Level Design

The menu/permission system consists of three configuration files, the feature configuration file, the menu configuration file and the Struts action configuration file.

The feature configuration file contains the definitions of system features. These features represent areas of the product that have access control. By configuring a user's access to features, one can simultaneously control access to the product and create a customized menu system that only displays available options. In this file, features are defined with attributes such as a minimum default user role required. These represent defaults and can be overridden through the exemplary iLrn system administrative tools.

The menu configuration file defines a hierarchical system of menus, which can be arbitrarily deep. Menu items define a feature id to link the menu item with a system feature. This allows the menu item to be conditionally available depending on the user's role and permissions. It also has defines a struts action id, which links it with the struts configuration file. In this was the incoming requests can be associated with menu items for automatic global navigation updates and for permission checking.

The struts configuration file contains all the normal information but also contains an id to link the actions with menu items. This provides for the ability to associate requests with menu items. When a user first logs in, the exemplary iLrn system creates a custom MenuSession object that is stored in the user's session. This object contains the customized menu hierarchy that is available to the user based on their role and permissions. The menu configuration tree is traversed and only nodes the user has access to are selected. In this way, the menus that a user sees are related to their permissions.

When incoming requests are received, an interceptor handles the request and checks to see if the request URL is associated with an Action that ism linked to a menu item. If so, permissions are checked to make sure the user has access to that feature. If so the request continues otherwise the access is blocked and a message returned to the user. In addition, the user's MenuSession is updated to reflect any possible change in global navigation location, so that the user's new position can be reflected in the rendering of the menu.

The Exemplary iLrn System Problem Type Web Services

Summary

These web services provide for integration of the exemplary iLrn system content into third party applications as well as integration of third party content into the exemplary iLrn system. The system is designed such that the external content can be embedded tightly within existing internal content system.

High Level Design

Two web services are available within the exemplary iLrn system for problem type integration. The first is a service that provides the exemplary iLrn system content to external systems. The second is a web service specification that can be implemented by an external system to provide content as well as an internal framework for the display and control of external content. Both web services interact through an XML schema which describes a method for communicating content and the grading of student responses.

Since the sharing of content can be bidirectional it is useful to separate the roles into server and client, though a system in the server role could also act in a client role in anther scenario. The server system will provide the content and grading to the client.

To integrate content, the client makes a request from the server, specifying the desired content and a desired destination address for the submit button. The server receives this request and renders the content as HTML. This content can then be embedded within the client system and returned to a user of the client's web application.

When the user of the client's application submits the request, the client receives the HTTP post and makes another call to the server's web service. The posted parameters are sent to the server so the server can grade the submission and allow the client to access the grade.

The framework represents an important integration point between the exemplary iLrn system and other systems.

Gradebook Query System

Summary

The gradebook query system allows instructors to perform customized searches through their students' assignment and course results by specifying narrowing criteria.

High Level Design

An API is provided within the exemplary iLrn system for the creation of gradebook queries using a number of configurable criteria. Criteria can be joined together to create a composite criterion.

Below are tables of supported criteria:

Course Criteria

| Property | Operators | Data Type |
|---|---|---|
| Adjusted course score | <, >, <=, >= | Double |
| Unadjusted course score | <, >, <=, >= | Double |
| Student ranking | Top n students, Bottom n | Integer |
| | students | |

Assignment Criteria

| Property | Operators | Data Type |
|---|---|---|
| Taken At (using StartedAt) | >, <, <=, >= | DateTime |
| TimeSpent | <, >, <=, >= | Long |
| Times Taken | <, >, <=, >= | Integer |
| Has Taken | Boolean | |
| AdjustedScore | <, >, <=, >= | Double |
| UnadjustedScore | <, >, <=, >= | Double |
| Is Manually Graded | Boolean | |
| Can take assignment | Boolean | |

When the criteria have been created, queries are performed and data passed through the criteria as a set of filters. The matching results are returned to the caller.

For large classes, an easy way to search through large numbers of student results is important.

we are tying the gradebook together with the communications system such that instructors can auto-send an e-mail to groups of students matching some (arbitrarily defined) gradebook pattern: e.g., send an e-mail to all students who scored>XX % on test 6, completed essay YY, have an overall course grade>ZbZ.

Tutorial Active Examples

Summary

When users are interacting with tutorial content, this system provides a way of associating related resources with the original item. These resources can be displayed when the exemplary iLrn system detects that the user needs additional assistance.

High Level Design

In tutorial items, a related resource property can be stored. This property can refer to other the exemplary iLrn system content resources such as other the exemplary iLrn system items. This property is populated by content specialists who can select appropriate related resources. When tutorial items are answered incorrectly, the exemplary iLrn system will display the related resources and allow the user to select them.

allows for the creation cross product referencing and expands the student's experience.

the Exemplary iLrn System Context System and Sequencing

Summary

The Context System is a component of the exemplary iLrn system that delivers learning sequences containing the exemplary iLrn system items. In particular it is useful for building non linear sequences of items and large amounts of content can be organized using its functionality.

High Level Design

A Context System application consists of an XML document which includes the following.
Sequencing elements that allow users to see items in particular orders and to navigate in different specified ways.
Filtering elements that can select certain items for presentation out of a set of items.
Content elements—the exemplary iLrn system items—for presentation to the user.
Elements that implement assorted behaviors, such as viewing results or sending an E-mail with user results to a specified address.
   This file is called the definition XML because it defines one or more learning sequences. The various XML tags are referred to as nodes within the context application.

When a series of applications or portions of applications are to share a common structure, the system supports an additional level of abstraction where the applications can be written in XML using an agreed upon structure that is not native to the context system. An XSL then be applied to the XML transforming it into the native context system format. This allows high level decisions such as content organization and navigation structure to be abstracted and encapsulated in the transform XSL, reducing duplication of those decisions.

Navigating through a context system application involves having an active terminal node in the definition XML. The active terminal node is used to build an XML output which is rendered into HTML for delivery to the user.

This architecture provides a clear division between the model portion of a product (the definition XML) and the view aspects (the HTML output and presentation XSL used to create it.)

In a simple case—as implemented in many products—the user simply moves across the terminal nodes of the tree from beginning to end. The context system offers many other options for navigating the XML tree.
Going back to items already visited.
Skipping content based on student performance.
Viewing different problems for different sessions.
Computer adaptive testing.
   In the simplest terms, writing a context system product involves writing a definition XML, as specified in this document. In practice, this usually means several input files that are processed at runtime into the definition xml file.
Source XML
A description of a product abstracted away from the definition XML.
Translating XSL
Translates a source XML into the definition XML. Abstracts redundancies in the structure of the product.
Item source file
A list of the exemplary iLrn system items, with little additional structure.
Presentation XSL
XSL for providing HTML to the user. Although the exemplary iLrn system provides default
XSL, most products provide custom XSL to control look and feel for the product.
   Interaction

The exemplary iLrn system platform receives information from a user through the user moving to a new URL. The ability for users to interact with the application is an attribute of nodes. The user requests a new URL from the system by clicking a submit or next button. The Context System reads name-value pairs from the URL into a

Map to be passed to the post method of node handlers. Each individual node handler checks for names it handles and—depending on node properties—saves state information or takes other actions.

A context system product can incorporate information for the system as name-value pairs using a form with a post.

In the source code, node post methods specify a limited number of parameters that can be listened for by assorted nodes. For instance, the tab navigator node has two values, open-tab and close-tab. The tab navigator node handler code checks for values of these two strings and acts accordingly (in this case, opening or closing the appropriate tab). The strings that each node handler looks for are listed with that node handler.

Gateway Questions

Summary

This is really just a way of configuring the exemplary iLrn system context system to provide a way of assessing the user's ability and directing them towards the correct resources. the exemplary iLrn system will display a gateway question which serves to determine whether the user is prepared to learn the material in a lesson. If the gateway question is answered correctly, a challenge question will be given. If the challenge question is answered correctly, the user can go on to the next section. If the challenge question is answered incorrectly, the user should proceed through the current section. If the gateway question is answered incorrectly the user is directed towards remedial resources.

In addition to gateway questions another common structure is based on pretests and posttests. The pretests are administered to gauge the user's ability, recommend a personalized learning plan, and the posttests are provided to assess that the user has learned the appropriate skills from the prescribed sections.

Custom Feedback Switching Based on Book Metadata

Summary

Allows the same the exemplary iLrn system content to be presented in a free version as well as a paid version, each having a different feedback mode.

High Level Design

When books are configured to use this system, two books are configured within the exemplary iLrn system. They will both share the same content.

Most the exemplary iLrn system content contains detailed feedback, including hints for the student and links to other resources. There is often a separate feedback message for each incorrect answer, because each answer may represent a different common mistake.

A free version allows items to be taken but without detailed item feedback for users. For example the student would either receive an “Answer correct” or “Answer incorrect” response when answering questions.

The paid version would display the same content with the detailed feedback messages.

Options exist for the instructor to select the feedback version they wish for their assignments, and an override exists within the Book metadata to force the feedback off for free products.

Represents a way of reusing content in different markets and a potential marketing opportunity to get users to upgrade to paid versions of content.

Session Persistence Framework

Summary

the exemplary iLrn system includes a session persistence framework that is designed to function as a failover system for system errors that make a server unresponsive. Users of the exemplary iLrn system that are connected to a failing system will be transparently moved to another system without losing their client session state, such as assessment progress.

High Level Design

Client state is tracked in the exemplary iLrn system using session cookies that Tomcat maintains. Clients are connected to the exemplary iLrn system systems through a load balancer that associates this session cookie with a single server in a load balanced pool. The load balancer is configured to detect system errors and redirect client sessions to another working system.

the exemplary iLrn system uses two other cookies that are managed separately from Tomcat. They store the Tomcat session id and a unique server name for the server the client is currently connected to.

The persistence framework allows stateful client objects to request that they be persisted to a database table. The table contains the client's unique session id, the unique server name, and the id of the data being stored. Periodically in the background, and at critical system transitions such when a user answers a test item, the objects representing the client state are serialized and written to this database table.

In the case of a failover, the client is redirected to another server. When a request is made to find the client's session, the request will fail because no session will exist within the Tomcat instance running on the new server. This failure is intercepted and the two the exemplary iLrn system cookies are examined. Any client state that had been written to the database while connected to the failed server is deserialized and a new session is created with the same data, effectively transferring the client's state from the failed system to the new system. The user remains logged in and their state such as progress in a test remains intact.

Prebuilt Course Syllabus feature Provides a method for the automatic creation of relevant course assignments when an instructor creates a course.

High Level Design

the exemplary iLrn system courses consist of assignments of various types for students. Traditionally, it has been the role of the instructor to define their course content. This feature allows a set of predefined assignments to be created for the instructor. An XML file containing a definition of the course contents can be associated with an the exemplary iLrn system book. When creating a course, the instructor will select a book to associate with the course as well as the course name. The exemplary iLrn system will then create the course along with the predefined assignments so that the course is ready to use immediately. The instructor is able to customize aspects of the syllabus such as assignment start and due dates, enabled/disabled status and assignment content. This provides a fast method of created a course skeleton linked to all relevant content within a book.

### CONCLUSION

The embodiments described above are intended only to illustrate and teach one or more ways of practicing or implementing the present invention, not to restrict its breadth or scope. The actual scope of the invention, which embraces all ways of practicing or implementing the teachings of the invention, is defined only by the following claims and their equivalents.

What is claimed is:

1. A system comprising:
a database of course work items, including a set of two or more active tutorial items;
means for associating one or more of the active tutorial items with one or more of the active course work items;
mean for providing one or more of the course work items to a client device in response to a user request; and
means, responsive to user interaction with the one or more of the provided course work items, for providing one or more of the associated active tutorial items to the client device.

2. The system of claim 1, wherein at least one of the course work items is logically associated with first and second user feedback options.

3. A system comprising:
a database of course work items, including a set of one or more documents of an online textbook, wherein one or more of the documents is logically associated with first and second feedback modes; and
mean for providing the one or more documents to a first client device in response to a first user request and to a second client device in response to a second user request, with the one or more documents provided to the first client device logically associated with the first feedback mode and those provided to the second client device logically associated with the second feedback mode.

4. The system of claim 3, further comprising:
means, responsive to user interaction with the one or more of the provided course work documents, for providing one or more of the associated active tutorial items to the client device.
